(19) United States
(12) Patent Application Publication
(10) Pub. No.: US 2025/0184008 A1
(43) Pub. Date: Jun. 5, 2025

(54) OPTICAL TRANSCEIVER, OPTICAL COMMUNICATION SYSTEM, AND METHOD FOR RECEIVING OPTICAL SIGNAL

(71) Applicant: NEC Corporation, Tokyo (JP)

(72) Inventor: Masayuki NAKANO, Tokyo (JP)

(73) Assignee: NEC Corporation, Tokyo (JP)

(21) Appl. No.: 18/953,204

(22) Filed: Nov. 20, 2024

(30) Foreign Application Priority Data
Nov. 30, 2023 (JP) 2023-202647

(51) Int. Cl. H04B 10/572; H04B 10/40; H04J 14/02

(52) U.S. Cl. CPC H04B 10/572; H04B 10/40; H04J 14/03

(57) ABSTRACT

An objective is to easily set a wavelength of an optical signal received by an optical transceiver. A first reception unit receives a first optical signal including identification information and reception wavelength information. A determination unit determines whether the identification information satisfies a predetermined condition. A wavelength filter has a tunable wavelength and transmits a second optical signal of the transmission wavelength included in an input optical signal. When the judgment unit judges that the identification information satisfies the predetermined condition, a wavelength instruction unit instructs the wavelength filter to use a transmission wavelength based on the reception wavelength information. A second reception unit receives a second optical signal.

### INCORPORATION BY REFERENCE

This application is based upon and claims the benefit of priority from Japanese patent application No. 2023-202647, filed on Nov. 30, 2023, the disclosure of which is incorporated herein in its entirety by reference.

### TECHNICAL FIELD

The present disclosure relates to an optical transceiver, an optical communication system, and a method for receiving an optical signal.

### BACKGROUND ART

In a general optical communication system, wavelength separating means such as a wavelength multiplexing filter or a wavelength switch is provided so that the optical signal from an optical transceiver on a transmission side can be received by an optical transceiver on a reception side. Thus, for example, as disclosed in Japanese unexamined patent application publication No. 2003-324456, a wavelength multiplexed optical signal from an optical transceiver on a transmission side is distributed to optical transceivers on a reception side for each wavelength by wavelength separating means on the reception side.

In a general system using the wavelength separating means, a reception wavelength of the optical transceiver on the reception side is determined by setting of a transmission wavelength of each port of the wavelength separating means.

### SUMMARY

On the other hand, in a recent optical communication system, it is desirable that the wavelength of an optical signal received by the optical transceiver on the reception side can be flexibly changed to reduce power consumption.

However, in a configuration using the wavelength separating means having a fixed transmission wavelength as described above, it is difficult to change the transmission wavelength. Therefore, the wavelength of the optical signal received by the optical transceiver on the reception side cannot be flexibly changed.

An aspect of the present disclosure is an optical transceiver including comprising: a first reception unit configured to receive a first optical signal including identification information and reception wavelength information; a determination unit configured to determine whether the identification information satisfies a predetermined condition; wavelength filter having a transmission wavelength that is tunable and configured to transmit a second optical signal of the transmission wavelength included in an input optical signal; an instruction unit configured to instruct the wavelength filter to use the transmission wavelength based on the reception wavelength information in a case where the determination unit determines that the identification information satisfies the predetermined condition; and a second reception unit configured to receive the second optical signal.

An aspect of the present disclosure is an optical communication system including: first and second communication apparatuses provided with a plurality of optical transceivers, respectively, in which at least one of the plurality of optical transceivers of the first communication apparatus includes: a first reception unit configured to receive a first optical signal including identification information and reception wavelength information output from any one of the plurality of optical transceivers of the second communication apparatus; a determination unit configured to determine whether the identification information satisfies a predetermined condition; a wavelength filter having a transmission wavelength that is tunable and configured to transmit a second optical signal of the transmission wavelength included in an input optical signal; an instruction unit configured to instruct the wavelength filter to use the transmission wavelength based on the reception wavelength information in a case where the determination unit determines that the identification information satisfies the predetermined condition; and a second reception unit configured to receive the second optical signal.

An aspect of the present disclosure is a method for receiving an optical signal including: receiving a first optical signal including identification information and reception wavelength information; determining whether the identification information satisfies a predetermined condition; instructing a wavelength filter that has a transmission wavelength that is tunable and configured to transmit a second optical signal of the transmission wavelength included in an input optical signal to use the transmission wavelength based on the reception wavelength information in a case where it is determined that the identification information satisfies the predetermined condition; and receiving the second optical signal.

According to the present disclosure, it is possible to easily set a wavelength of an optical signal received by an optical transceiver.

### BRIEF DESCRIPTION OF DRAWINGS

The above and other aspects, features and advantages of the present disclosure will become more apparent from the following description of certain exemplary embodiments when taken in conjunction with the accompanying drawings, in which:

### BRIEF DESCRIPTION OF DRAWINGS

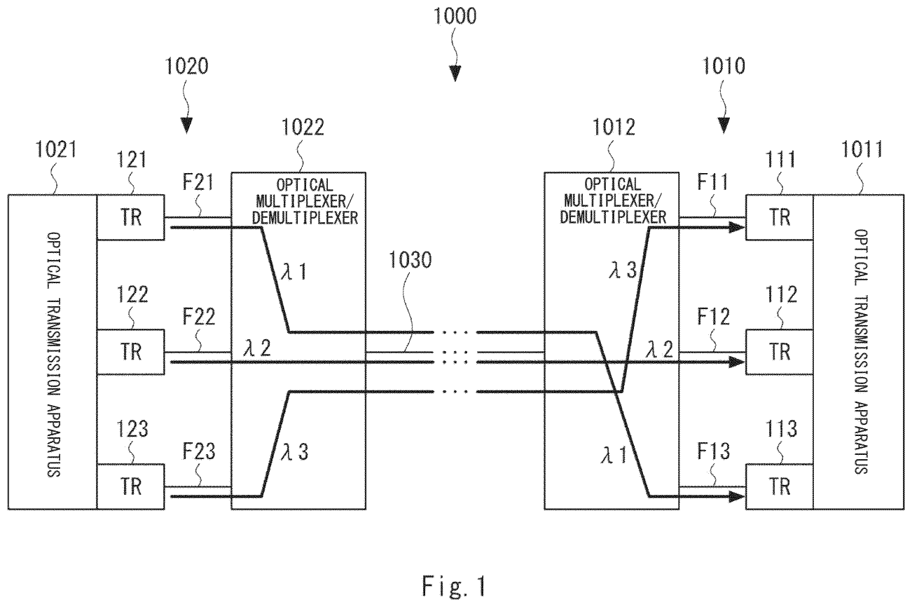

FIG. 1 is a block diagram schematically showing an example of a configuration of an optical communication system using an optical transceiver according to an example embodiment

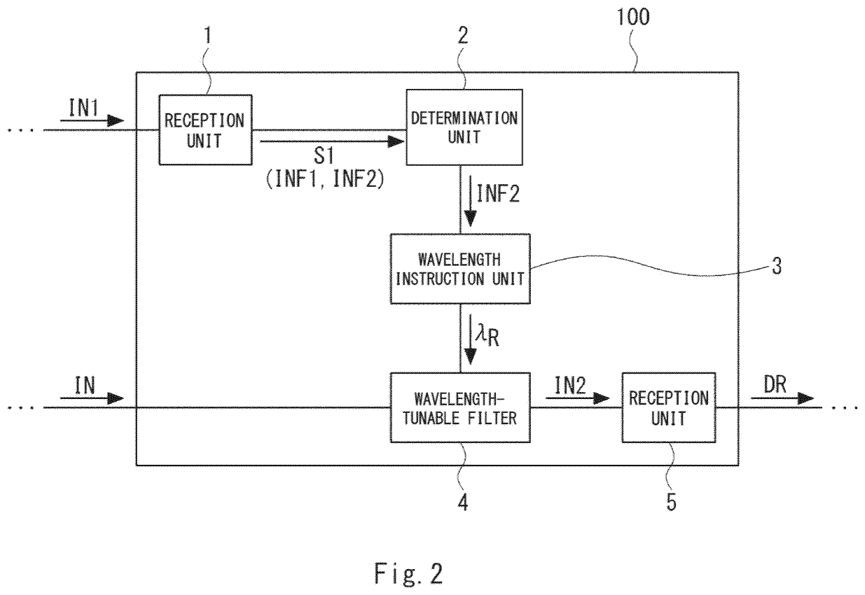

FIG. 2 is a block diagram schematically showing a configuration of an optical transceiver according to an example embodiment;

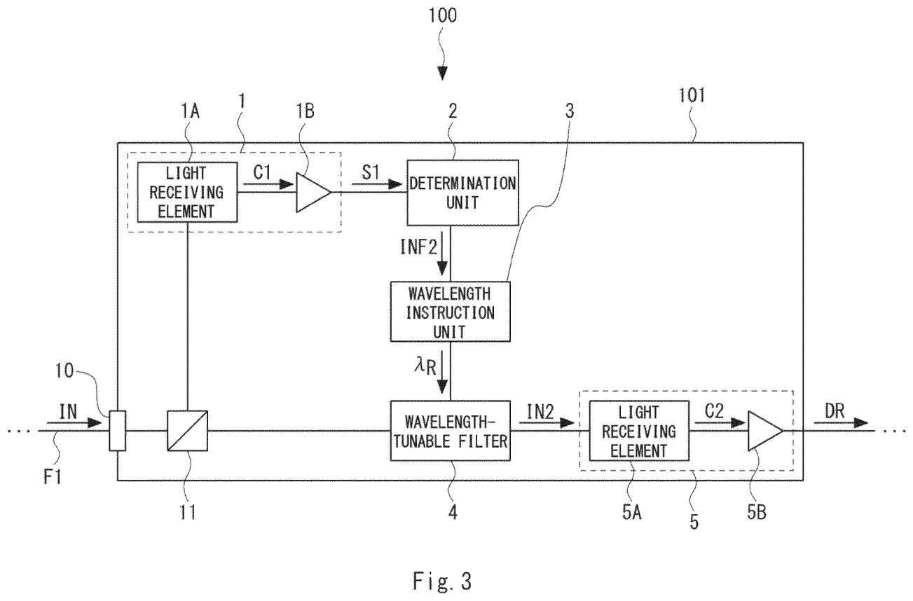

FIG. 3 is a block diagram showing a configuration of an optical transceiver according to an example embodiment in more detail;

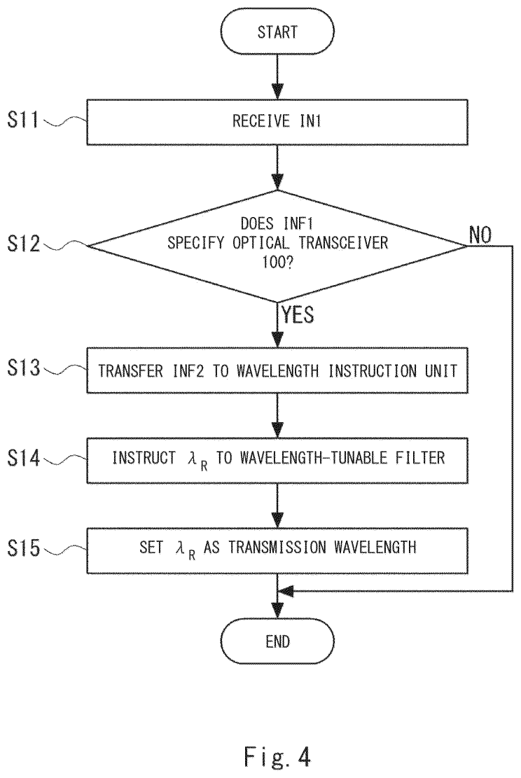

FIG. 4 is a flowchart of a setting operation of a reception wavelength in an optical transceiver according to an example embodiment;

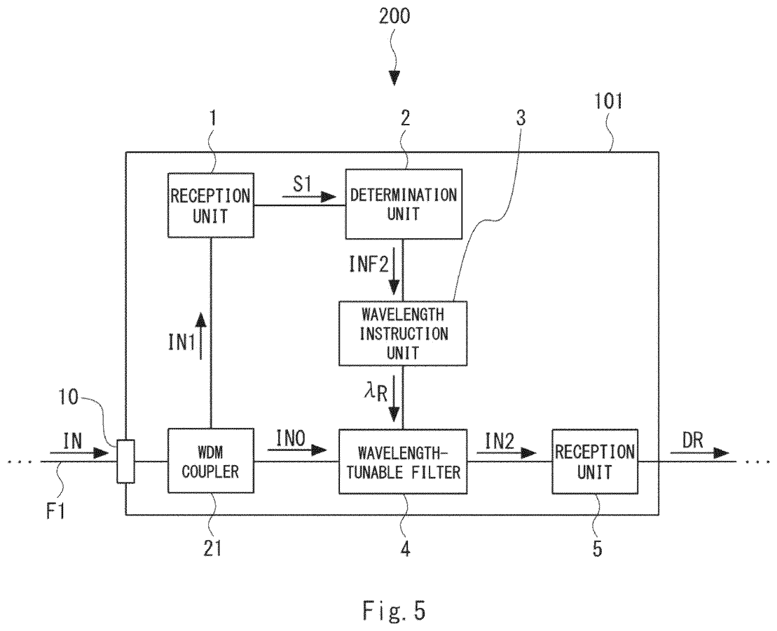

FIG. 5 is a block diagram schematically showing a configuration of an optical transceiver according to an example embodiment;

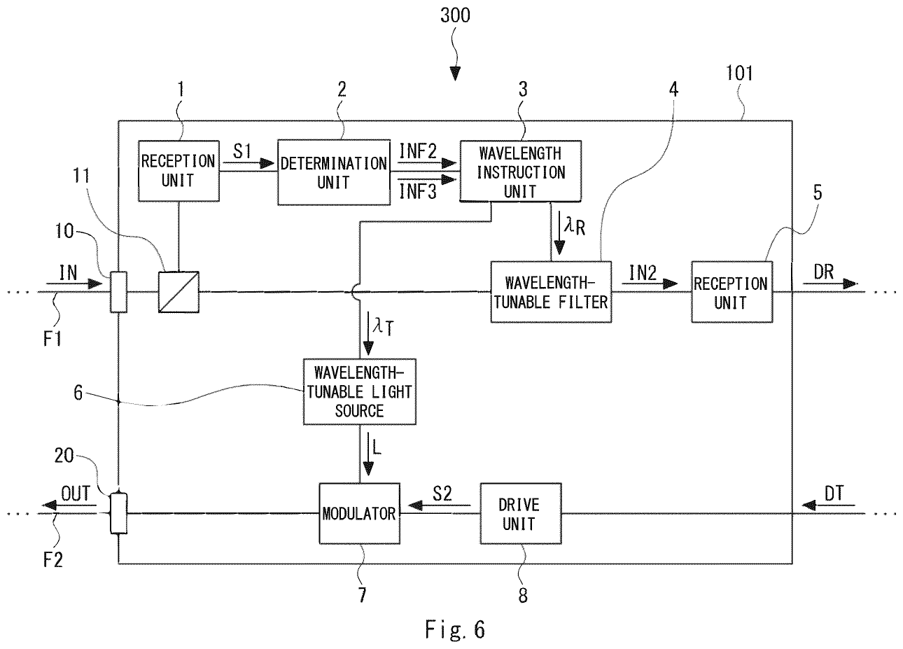

FIG. 6 is a block diagram schematically showing a configuration of an optical transceiver according to an example embodiment;

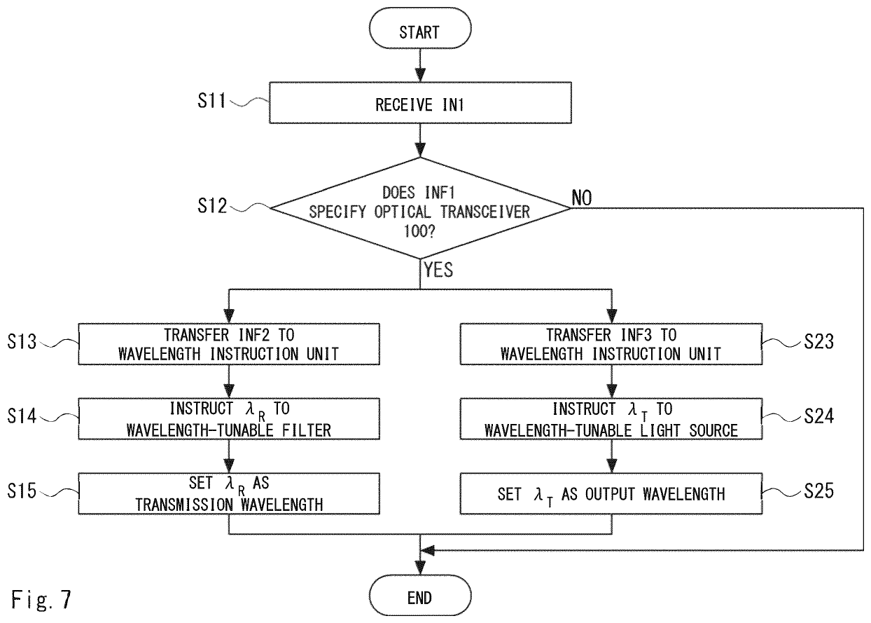

FIG. 7 is a flowchart of setting operation of a transmission wavelength in an optical transceiver according to an example embodiment;

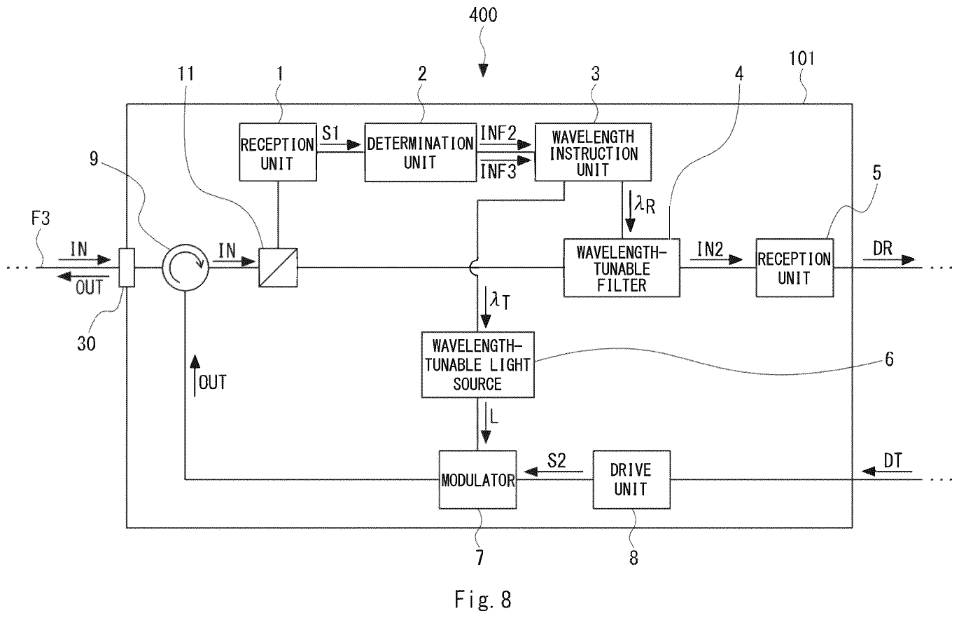

FIG. 8 is a block diagram schematically showing a configuration of an optical transceiver according to an example embodiment;

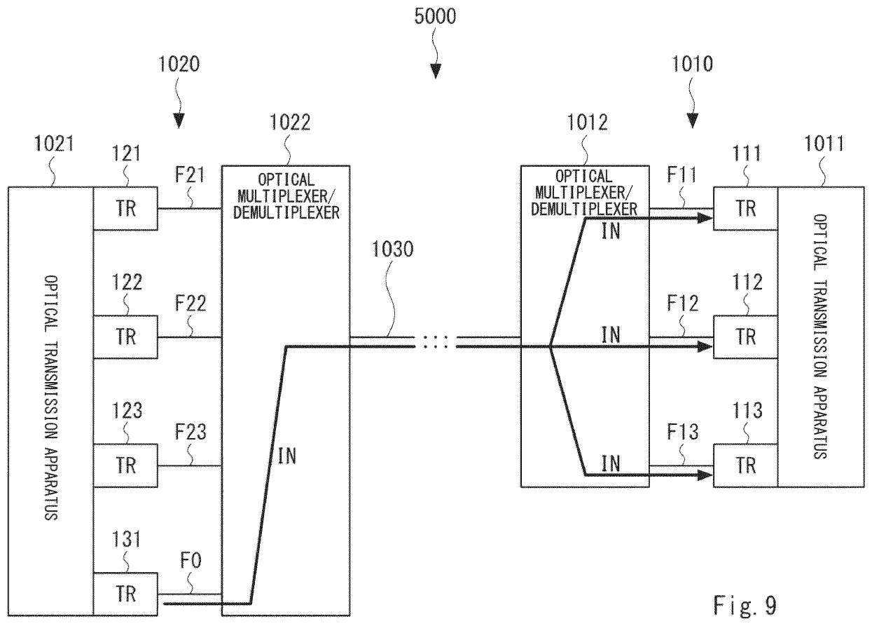

FIG. 9 is a block diagram schematically showing an example of a configuration of an optical communication system using an optical transceiver according to an example embodiment; and

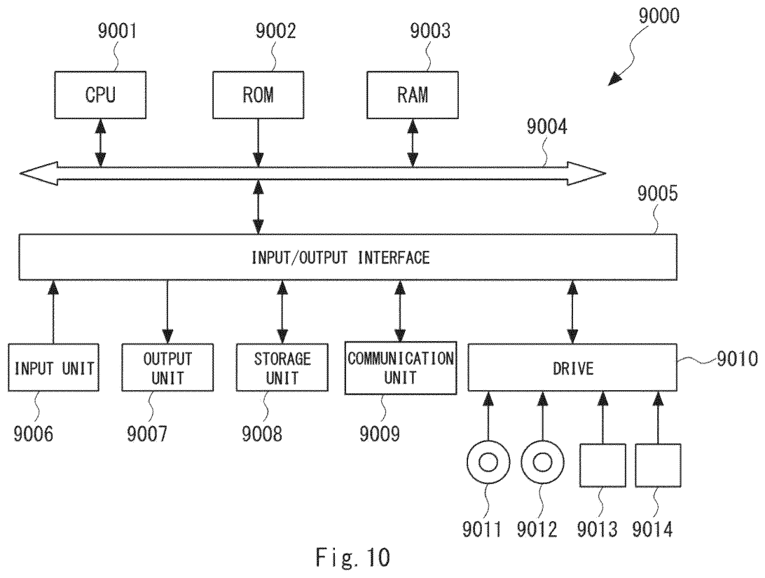

FIG. 10 is a diagram showing an example of a hardware configuration for implementing a determination unit and a wavelength instruction unit.

### EXAMPLE EMBODIMENTS

An example embodiment according to the present disclosure will be described hereinafter with reference to the drawings. The same elements are assigned the same reference numerals (or symbols) throughout the drawings, and redundant descriptions thereof will be omitted as appropriate.

An example embodiment in the following descriptions may be applied to any of example embodiments described hereinafter or to a combination of two or more of these example embodiments, and the application thereof is not limited to any specific example embodiment.

### First Example Embodiment

An optical transceiver according to a first example embodiment will be described. The optical transceiver according to the first example embodiment is used for exchanging optical signals having a specific wavelength between two communication apparatuses. FIG. 1 is a block diagram schematically showing an example of a configuration of an optical communication system using an optical transceiver according to an example embodiment. The optical communication system 1000 shown in FIG. 1 includes communication apparatuses 1010 and 1020. The communication apparatus 1010 and the communication apparatus 1020 are connected by an optical transmission path 1030 formed of an optical fiber cable or the like. The communication apparatuses 1010 and 1020 are each provided with a plurality of optical transceivers. Here, for simplicity, an example in which the communication apparatuses 1010 and 1020 are each provided with three optical transceivers will be described.

The communication apparatus 1010 includes an optical transmission apparatus 1011, an optical multiplexer/demultiplexer 1012, and optical transceivers 111 to 113. The optical transceivers 111 to 113 are attached to the optical transmission apparatus 1011. The optical transmission apparatus 1011 outputs signals such as transmission data signals to the optical transceivers 111 to 113. The optical transceivers 111 to 113 convert the transmission data signals into optical signals and output the converted optical signals to the optical multiplexer/demultiplexer 1012 via optical fibers F11 to F13, respectively. The optical multiplexer/demultiplexer 1012 outputs a multiplexed optical signal obtained by multiplexing the optical signals from the optical transceivers 111 to 113 to the communication apparatus 1020 via the optical transmission path 1030. The optical multiplexer/demultiplexer 1012 demultiplexes a multiplexed optical signal output from the communication apparatus 1020 and distributes the demultiplexed optical signals to the optical transceivers 111 to 113. The optical transceivers 111 to 113 convert the received optical signals into received data signals and output the received data signals to the optical transmission apparatus 1011. Hereinafter, the optical multiplexer/demultiplexer 1012 is also referred to as optical signal distribution means.

The communication apparatus 1020 has the same configuration as the communication apparatus 1010. The communication apparatus 1020 includes an optical transmission apparatus 1021, an optical multiplexer/demultiplexer 1022, and optical transceivers 121 to 123. The optical transceivers 121 to 123 are attached to the optical transmission apparatus 1021. The optical transmission apparatus 1021 outputs signals such as transmission data signals to the optical transceivers 121 to 123. The optical transceivers 121 to 123 converts the transmission data signals into optical signals and output the converted optical signals to the optical multiplexer/demultiplexer 1022 via optical fibers F21 to F23, respectively. The optical multiplexer/demultiplexer 1022 outputs a multiplexed optical signal obtained by multiplexing the optical signals from the optical transceivers 121 to 123 to the communication apparatus 1010 via the optical transmission path 1030. The optical multiplexer/demultiplexer 1022 demultiplexes the multiplexed optical signal output from the communication apparatus 1010 and distributes the demultiplexed optical signals to the optical transceivers 121 to 123. The optical transceivers 121 to 123 convert the received optical signals into received data signals and output the received data signals to the optical transmission apparatus 1021. Hereinafter, the optical multiplexer/demultiplexer 1022 is also referred to as the optical signal distribution means.

In the following, for the sake of simplification of the description, a case where the communication apparatus 1010 is an apparatus on a reception side and the communication apparatus 1020 is an apparatus on a transmission side will be described. The optical transceivers 121 to 123 output the optical signals of different wavelengths. The optical transceivers 111 to 113 receive the optical signals of different wavelengths, respectively. For example, the optical transceivers 121 to 123 outputs the optical signals of wavelengths λ1 to λ3, respectively. In the present example, the optical transceivers 111 to 113 receive the optical signals of the wavelengths λ3, λ2, and λ1, respectively.

As described above, the optical signals of the wavelengths λ1 to λ3 are multiplexed by the optical multiplexer/demultiplexer 1022. The multiplexed optical signal output from the optical multiplexer/demultiplexer 1022 is distributed to the optical transceivers 111 to 113 by the optical multiplexer/demultiplexer 1012.

In the optical communication system 1000, the wavelength-multiplexed optical signal output from the communication apparatus 1020 is distributed to the optical transceivers 111 to 113 by the optical multiplexer/demultiplexer 1012. However, when an operation of the optical communication system 1000 starts or when an optical transceiver is newly attached to the optical transmission apparatus 1011, it is unknown what wavelength of an optical signal is transmitted to the optical transceiver. That is, in this case, the wavelengths of the optical signals to be received have not been set to the optical transceivers 111 to 113. Therefore, for the optical transceivers 111 to 113 to receive the optical signals of the wavelengths λ3, λ2, and λ1, setting of the wavelengths of the optical signals to be received is needed.

Therefore, in the present example embodiment, the optical transceivers 111 to 113 are configured to set the wavelengths of the optical signals to be received based on an input optical signal in a state where the wavelengths of the optical signals to be received have not been set.

In the following, for the sake of simplicity, an optical transceiver having a configuration common to the optical transceivers 111 to 113 will be described.

FIG. 2 is a block diagram schematically showing a configuration of an optical transceiver according to an example embodiment. An optical transceiver 100 shown in FIG. 2 is an optical transceiver applicable to each of the optical transceivers 111 to 113. The optical transceiver 100 includes a reception unit 1, a determination unit 2, a wavelength instruction unit 3, a wavelength-tunable filter 4, and a reception unit 5.

The optical transceiver 100 receives an optical signal IN including information used for wavelength setting, which is output from, for example, another optical transceiver. In the example shown in FIG. 1, the optical signal IN may be output from, for example, part or all of the optical transceivers 121 to 123. The optical signal IN may be, for example, a wavelength-multiplexed optical signal. The optical signal IN includes at least an optical signal IN1 indicating identification information INF1 of the optical transceiver, which is information used for the wavelength setting of the optical transceiver, and reception wavelength information INF2 specifying the wavelength of the optical signal received by the optical transceiver. The optical signal IN may include an optical signal IN2, which is a data signal referred to as a so-called main signal. In this case, the main signal may be an optical signal obtained by wavelength-multiplexing the optical signal IN2 and an optical signal having a wavelength different from that of the optical signal IN2. In the following, the optical signal IN1 is also referred to as a first optical signal. The optical signal IN2 is also referred to as a second optical signal.

The optical signal IN is also referred to as a third optical signal.

In the present example embodiment, the optical signal IN1 is superimposed on the optical signal IN2 by modulating the optical signal IN2 included in the optical signal IN by amplitude shift keying (ASK).

The modulation method applied to the optical signal IN1 is not limited to ASK, and for example, the optical signal IN1 and the optical signal IN2 may be input to the optical transceiver 100 in a time division manner. In this case, the optical signal IN1 and the optical signal IN2 can be received separately depending on timings at which they are input to the optical transceiver 100.

The reception unit 1 receives the optical signal IN1. The reception unit 1 converts the optical signal IN1 into a received signal S1 which is an electric signal. The reception unit 1 outputs the received signal S1 to the determination unit 2. Since the received signal S1 is obtained by photoelectric conversion of the optical signal IN, the received signal S1 includes the identification information INF1 and the reception wavelength information INF2. Hereinafter, the reception unit 1 is also referred to as a first reception unit or first reception means.

The determination unit 2 extracts the identification information INF1 and the reception wavelength information INF2 from the received signal S1. The determination unit 2 determines whether the optical transceiver specified by the identification information INF1 is the optical transceiver 100 on which the determination unit 2 is mounted. The determination unit 2 transfers the reception wavelength information INF2 to the wavelength instruction unit 3 in a case where the identification information INF1 specifies the optical transceiver 100. For example, the optical transceiver 100 may be provided with a memory (not shown) for storing unique identification information assigned thereto. In the present example, specifically, it is assumed that contents of the identification information assigned to the optical transceivers 111 to 113 shown in FIG. 1 are different from each other. In this case, in a case where the identification information INF1 extracted from the received signal matches the unique identification information stored in the memory (not shown), the determination unit 2 transfers the reception wavelength information INF2 to the wavelength instruction unit 3. Hereinafter, the determination unit 2 is also referred to as determination means.

The wavelength instruction unit 3 acquires a wavelength AR of the optical signal specified by the reception wavelength information INF2 in accordance with the determination result of the determination unit 2. Hereinafter, the wavelength AR is referred to as a reception wavelength AR. The wavelength instruction unit 3 instructs the wavelength-tunable filter 4 to use the acquired reception wavelength AR. Hereinafter, the wavelength instruction unit 3 is also referred to as instruction means.

The wavelength-tunable filter 4 sets a transmission wavelength so that an optical signal of the instructed reception wavelength AR in the input optical signals passes through. Note that a transmission wavelength of the wavelength-tunable filter 4 is referred to as a first transmission wavelength. Thus, the wavelength-tunable filter 4 transmits only the optical signal IN2 of the instructed reception wavelength AR in the input optical signal IN.

The reception unit 5 receives the optical signal IN2 of the wavelength AR that has passed through the wavelength-tunable filter 4. Then, the reception unit 5 converts the optical signal IN2 of the wavelength AR into a received data signal DR and outputs the received data signal DR. Hereinafter, the reception unit 5 is also referred to as a second reception unit or second reception means.

FIG. 3 is a block diagram showing a configuration of an optical transceiver according to an example embodiment in more detail. The optical transceiver 100 shown in FIG. 3 further includes an input port 10 and an optical branching unit 11.

The input port 10 is provided in a housing 101 of the optical transceiver 100 and is configured, for example, as a part of a pluggable optical receptor. The optical signal IN is transmitted, for example, by an optical fiber F1 connected to the input port 10 via an optical connector, and is input to the optical transceiver 100. The optical signal IN is transmitted from the input port 10 to the optical branching unit 11.

The optical branching unit 11 branches the input optical signal IN to the reception unit 1 and the wavelength-tunable filter 4. The optical branching unit 11 may be configured as, for example, an optical coupler or an optical splitter. In this case, the optical branching unit 11 can branch a part of the optical signal IN to the reception unit 1 at a predetermined ratio. The optical branching unit 11 transmits the unbranched part of the optical signal IN to the wavelength-tunable filter 4.

In the present example, the reception unit 1 includes, for example, a light receiving element 1A and an amplifier 1B. The amplifier 1B is, for example, a transimpedance amplifier (TIA). The light receiving element 1A receives the optical signal IN including the optical signal IN1 and outputs a current signal C1 to the amplifier 1B. The amplifier 1B converts the current signal C1 into the received signal S1 that is a voltage signal. The amplifier 1B then outputs the received signal S1 to the determination unit 2.

In the present example, the reception unit 5 includes, for example, a light receiving element 5A and an amplifier 5B. The amplifier 5B is, for example, a TIA. The light receiving element 5A receives the optical signal IN2 of the wavelength AR that is the data signal, and outputs a current signal C2 to the amplifier 5B. The amplifier 5B converts the current signal C2 into the received data signal DR that is a voltage signal. The amplifier 5B then outputs the received data signal DR.

Next, a setting operation of the reception wavelength in the optical transceiver 100 will be described. FIG. 4 is a flowchart of a setting operation of a reception wavelength in an optical transceiver according to an example embodiment.

### Step S11

The reception unit 1 receives the optical signal IN1 input to the optical transceiver 100. Then, the reception unit 1 outputs the received signal S1 to the determination unit 2.

### Step S12

Based on the received signal S1, the determination unit 2 determines whether the optical transceiver specified by the identification information INF1 is the optical transceiver 100 on which the determination unit 2 is mounted. In a case where the identification information INF1 does not specify the optical transceiver 100, the determination unit 2 ends the process.

### Step S13

In a case where the identification information INF1 specifies the optical transceiver 100, the determination unit 2 transfers the reception wavelength information INF2 to the wavelength instruction unit 3.

### Step S14

The wavelength instruction unit 3 instructs the wavelength-tunable filter 4 to use the reception wavelength AR specified by the reception wavelength information INF2.

### Step S15

The wavelength-tunable filter 4 sets the transmission wavelength thereof so that the instructed reception wavelength AR passes therethrough. Thus, the wavelength-tunable filter 4 can transmit only the optical signal IN2 of the instructed reception wavelength AR in the optical signals IN.

The described setting operation of the reception wavelength may be performed as an initial setting when the optical transceiver is newly installed. The described setting operation of the reception wavelength may be performed to switch the reception wavelength during the operation of the optical transceiver. For example, it is assumed that the wavelength instruction unit 3 has already instructed the wavelength-tunable filter 4 to use a reception wavelength AR1 at the start of the operation shown in FIG. 4. At this time, the wavelength-tunable filter 4 transmits the optical signal IN2 of the reception wavelength AR1. In this state, in the case where the determination unit 2 determines in Step S12 that the identification information INF1 does not specify the optical transceiver 100, the determination unit 2 ends the process. As a result, the wavelength-tunable filter 4 continues to transmit the optical signal IN2 of the reception wavelength AR1. On the other hand, in the case where the determination unit 2 determines that the identification information INF1 specifies the optical transceiver 100, the wavelength instruction unit 3 instructs the wavelength-tunable filter 4 to use a reception wavelength AR2 specified by the reception wavelength information INF2. As a result, the wavelength of light transmitted by the wavelength-tunable filter 4 is switched from the reception wavelength AR1 to the reception wavelength λ_{R2}.

As described above, the optical transceiver 100 can refer to the identification information INF1 to identify whether the reception wavelength information INF2 is given to the optical transceiver 100. In the case where the identification information INF1 specifies the optical transceiver 100, the optical transceiver 100 can set the transmission wavelength of the wavelength-tunable filter 4 to the reception wavelength λ_{R} based on the reception wavelength information INF2. Thus, the optical transceiver 100 can receive the optical signal IN2 of the wavelength λ_{R} to be received by the optical transceiver 100.

In the case where the identification information INF1 does not specify the optical transceiver 100, the optical transceiver 100 does not perform the setting operation of the reception wavelength. Thus, it is possible to reliably prevent the optical transceiver 100 from erroneously setting the reception wavelength assigned to another transceiver as its own reception wavelength.

As described above, according to the present configuration, the wavelength setting of the optical transceiver can be performed using a network used for transmitting and receiving optical signals without using any other means such as a network for the wavelength setting of the optical transceiver. As a result, the optical transceiver according to the present example embodiment can be easily applied to a general optical network.

In the above description, each of the optical transceivers 121 to 123 is the optical transceiver on the transmission side, but this is merely an example. For example, the optical transceivers 111 to 113 may be on the transmission side and the optical transceivers 121 to 123 may be on the reception side. In this case, by using the optical transceiver 100 as the optical transceivers 121 to 123, setting of reception wavelengths of the optical transceivers 121 to 123 may be performed in the same manner. This also applies to the following example embodiments.

### Second Example Embodiment

In the first example embodiment, an example where the optical signal IN1 is superimposed on the optical signal IN by the ASK and an example where the optical signal IN1 and the main signal are input in a time-division manner. However, these are merely examples. For example, the optical signal IN may be an optical signal in which the optical signal IN1 and the main signal are wavelength-multiplexed. In this case, the optical transceiver may receive the optical signal IN1 by wavelength-separating the optical signal IN1 from the optical signal IN.

FIG. 5 is a block diagram schematically showing a configuration of an optical transceiver according to an example embodiment. In an optical transceiver 200 shown in FIG. 5, the optical branching unit 11 is replaced with an optical branching unit 21 as compared with the optical transceiver 100.

The optical branching unit 21 is configured as a WDM (wavelength division demultiplexing) coupler, for example. The optical branching unit 21 selectively wavelength-separates the optical signal IN1 that is wavelength-multiplexed to the optical signal IN. The optical branching unit 21 outputs the separated optical signal IN1 to the reception unit 1. The optical branching unit 21 transmits an optical signal of a wavelength other than the wavelength-separated optical signal IN1 in the optical signal IN to the wavelength-tunable filter 4.

Since the other configuration and the wavelength setting operation of the optical transceiver 200 are the same as those of the optical transceiver 100, the description thereof will be omitted.

As described above, the optical transceiver 200 can set the reception wavelength λ_{R} specified by the reception wavelength information INF2 as a reception wavelength of the optical transceiver 200. Thus, the optical transceiver 200 can receive the optical signal IN2 of the reception wavelength λ_{R} of the optical transceiver 200 in the same manner as the optical transceiver 100.

Further, as in the first example embodiment, it is possible to reliably prevent the optical transceiver 200 from erroneously setting the reception wavelength assigned to another transceiver as its own reception wavelength.

### Third Example Embodiment

In the first example embodiment, the setting of the reception wavelength of the optical transceiver based on the received optical signal has been described. In contrast, the optical transceiver can set the wavelength of an optical signal to be transmitted based on the received optical signal. Therefore, in the present example embodiment, an optical transceiver that sets not only the reception wavelength but also a transmission wavelength based on the received optical signal will be described.

FIG. 6 is a block diagram schematically showing a configuration of an optical transceiver according to an example embodiment. An optical transceiver 300 shown in FIG. 6 is further provided with a wavelength-tunable light source 6, a modulator 7, a drive unit 8, and an output port 20 as compared with the optical transceiver 100 according to the first example embodiment.

In the present example embodiment, the optical signal IN1 includes not only the identification information INF1 and the reception wavelength information INF2 but also transmission wavelength information INF3. The transmission wavelength information INF3 is information for specifying a transmission wavelength Ar that is the wavelength of an optical signal OUT transmitted by the optical transceiver. Note that the transmission wavelength of the transmission signal from the optical transceiver is referred to as a second transmission wavelength.

The wavelength-tunable light source 6 outputs a light L, which is a laser light, to the modulator 7. The wavelength-tunable light source 6 controls a wavelength of the light L in such a manner that the wavelength of the light L becomes the transmission wavelength Ar instructed by the wavelength instruction unit 3 based on the transmission wavelength information INF3.

A transmission data signal DT output from apparatuses external to the optical transceiver 300, such as an optical transmission apparatus, is input to the drive unit 8. The drive unit 8 outputs a modulation signal S2 to the modulator 7 for performing a modulation operation in response to the transmission data signal DT. Although not shown, the drive unit 8 can provide various signals and voltages used for the modulation operation in the modulator 7, such as a bias voltage applied to the modulator 7.

The modulator 7 modulates the light L from the wavelength-tunable light source 6 into the optical signal OUT in response to the modulation signal S2 by a predetermined modulation scheme. The modulator 7 outputs the modulated optical signal OUT to a communication partner of the optical transceiver 300 via the output port 20. Hereinafter, the optical signal OUT is referred to as a fourth optical signal.

The output port 20 is provided in the housing 101 of the optical transceiver 300 and is configured, for example, as a part of a pluggable optical receptor. The optical signal OUT is transmitted, for example, by an optical fiber F2 connected to the output port 20 via an optical connector and transmitted to the communication partner of the optical transceiver 300.

Next, a setting operation of the transmission wavelength in the optical transceiver 300 will be described. FIG. 7 is a flowchart of a setting operation of a transmission wavelength in an optical transceiver according to an example embodiment.

### Steps S11 to S15

Since Steps S11 to S15 are the same as those in FIG. 4, a redundant description thereof will be omitted.

### Step S23

In the case where the identification information INF1 specifies the optical transceiver 300, the determination unit 2 transfers the transmission wavelength information INF3 to the wavelength instruction unit 3.

### Step S24

The wavelength instruction unit 3 instructs the wavelength-tunable light source 6 to use the wavelength Ar specified by the transmission wavelength information INF3.

### Step 25

The wavelength-tunable light source 6 performs wavelength control so that the wavelength of the light L becomes the transmission wavelength λ_{T}. As described above, the optical transceiver 300 can set the reception wavelength in the same manner as the optical transceiver according to the first example embodiment.

Further, the optical transceiver 300 can set the transmission wavelength λ_{T} specified by the received transmission wavelength information INF3 as the wavelength of the light L output from the wavelength-tunable light source 6.

The setting operation of the transmission wavelength described above may be performed as an initial setting when the optical transceiver is newly installed. The setting operation of the transmission wavelength may be performed to switch the transmission wavelength during the operation of the optical transceiver. For example, it is conceivable that, at the start of the operation shown in FIG. 7, the wavelength instruction unit 3 have already instructed the wavelength-tunable light source 6 to use a transmission wavelength λ_{T1}. In this case, the wavelength-tunable light source 6 outputs the light L of the transmission wavelength λ_{T1}. In this state, in the case where the determination unit 2 determines in Step S12 that the identification information INF1 does not specify the optical transceiver 300, the determination unit 2 ends the process. As a result, the wavelength-tunable light source 6 continues to output the light L having the transmission wavelength λ_{T1}. On the other hand, in the case where the determination unit 2 determines that the identification information INF1 specifies the optical transceiver 300, the wavelength instruction unit 3 instructs the wavelength-tunable light source 6 to use a transmission wavelength λ_{T2} specified by the transmission wavelength information INF3.

As a result, the wavelength of the light L output from the wavelength-tunable light source 6 is switched from the transmission wavelength λ_{T1} to the transmission wavelength λ_{T2}.

In the case where the identification information INF1 does not specify the optical transceiver 300, the optical transceiver 300 does not perform the setting operation of the transmission wavelength. Thus, it is possible to reliably prevent the optical transceiver 300 from erroneously setting the transmission wavelength assigned to another transceiver as its own transmission wavelength.

Therefore, the optical transceiver 300 can collectively set the reception wavelength and the transmission wavelength by receiving the optical signal IN1 once.

### Fourth Example Embodiment

In a fourth example embodiment, the optical transceiver in which the input port 10 and the output port 20 are provided separately has been described. However, the arrangement of the ports is not limited to this. In the present example embodiment, an optical transceiver in which one input/output port capable of bi-directionally transmitting optical signals is provided.

FIG. 8 is a block diagram schematically showing a configuration of an optical transceiver according to an example embodiment. In the optical transceiver 400 shown in FIG. 8, the input port 10 and the output port 20 are replaced with an input/output port 30 as compared with the optical transceiver 300 according to the third example embodiment. The optical transceiver 400 is further provided with an optical circulator 9 as compared with the optical transceiver 300. Hereinafter, the optical circulator 9 is also referred to as optical distribution means.

The input/output port 30 is provided in the housing 101 of the optical transceiver 400 and is configured as a part of, for example, a pluggable optical receptor. The input/output port 30 is connected to an optical fiber F3 via an optical connector.

The optical circulator 9 is interposed between the input/output port 30 and the optical branching unit 11. The optical circulator 9 is configured to output the optical signal IN input from the input/output port 30 to the optical branching unit 11, and to output the optical signal input from the modulator 7 to the input/output port 30.

The optical signal IN is transmitted by the optical fiber F3 and input to the input/output port 30. The optical signal IN is transmitted from the input/output port 30 to the optical branching unit 11 via the optical circulator 9.

The optical signal OUT is output from the modulator 7 to the input/output port 30 via the optical circulator 9. The optical signal OUT is transmitted from the input/output port 30 to a communication partner of the optical transceiver 400 via the optical fiber F3.

As described above, the optical transceiver 400 can transmit and receive optical signals through one input/output port by providing the optical circulator 9. Thus, the optical transceiver 400 can not only perform the wavelength setting operation in the same manner as the optical transceiver 100, but also can correspond to single-core bidirectional optical communication.

The optical circulator 9 is an example of the optical distribution means, and other configurations may be appropriately used as the optical distribution means.

### Fifth Example Embodiment

In the example embodiments described above, the optical signal IN including the optical signal IN1 is transmitted from an opposing optical transceiver. In the case of FIG. 1, for example, the optical signal IN is transmitted from the opposing optical transceivers 121 to 123 to perform the wavelength setting of the optical transceivers 111 to 113. However, this is merely an example, and the optical signal IN including the optical signal IN1 may be transmitted from another optical transceiver provided for transmitting setting information.

FIG. 9 is a block diagram schematically showing an example of a configuration of an optical communication system using an optical transceiver according to an example embodiment. In an optical communication system 5000 of FIG. 9, as compared with the optical communication system 1000 of FIG. 1, an optical transceiver 131 provided for transmitting an optical signal for wavelength setting is further attached to the optical transmission apparatus 1021 of the communication apparatus 1020. The optical transceiver 131 is connected to the optical multiplexer/demultiplexer 1022 by an optical fiber F0.

The optical transceiver 131 transmits, for example, the optical signal IN for wavelength setting to the opposing optical transceivers 111 to 113 in response to a wavelength setting command from the communication apparatus 1020 or a host apparatus of the communication apparatus 1020 that is not shown in the drawing. Thus, the optical transceivers 111 to 113 can perform the setting operation of the transmission wavelength and the reception wavelength, as described in the above-described example embodiment.

The optical transceiver 131 may have a function of transmitting an optical signal for transmitting a data signal.

In the example embodiments described above, it is necessary to provide not only a function of transmitting an optical signal for transmitting a data signal but also a function of transmitting an optical signal for wavelength setting to each of the optical transceivers 121 to 123.

In contrast, in the present configuration, only by providing a function of transmitting an optical signal IN for wavelength setting only to the optical transceiver 131 and applying it to an existing optical communication system, the wavelength setting of the opposing optical transceiver can be performed. Therefore, it is more suitable for introduction into an existing optical communication system.

### Other Example Embodiments

Although the present disclosure is described above with reference to example embodiments, the present disclosure is not limited to the above-described example embodiments. For example, the optical transmission apparatus to which the optical transceiver according to the above-described example embodiments is attached may be various apparatuses used in an optical communication system. For example, in optical communication between terminal stations, the optical transmission apparatus may be an apparatus installed in the terminal station.

The optical transceiver according to the above-described example embodiments may be connected not only to the optical transmission apparatus but also to various apparatuses. For example, in optical communication in an optical front hole, the optical transceiver according to the above-described example embodiments may be applied to one or both of the optical transceiver attached to an apparatus in a station building and the optical transceiver attached to an antenna device.

The optical transceiver 300 according to the third example embodiment has been described as the modification of the optical transceiver 100 according to the first example embodiment, but this is merely an example. As in the second example embodiment, the optical transceiver according to the third example embodiment may be configured to provide a WDM coupler to receive the optical signal IN1 that is wavelength-multiplexed to the main signal.

Although the optical transceiver 400 according to the fourth example embodiment has been described as the modification of the optical transceiver 300 according to the third example embodiment, this is merely an example. As in the second example embodiment, the optical transceiver according to the fourth example embodiment may have a configuration in which a WDM coupler is provided to receive the optical signal IN1 the is wavelength-multiplexed to the main signal.

In the above-described example embodiments, the determination unit and the wavelength instruction unit according to the present disclosure have been described mainly as hardware configurations, but the configuration according to the present disclosure is not limited the hardware configurations. That is, an arbitrary process may be implemented by causing a CPU (Central Processing Unit) to execute a computer program. In this case, the computer program may be stored by using various types of non-transitory computer readable media and supplied to the computer. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, a CD-R/W, and a semiconductor memory (such as a mask ROM, a PROM (Programmable ROM), an EPROM (Erasable PROM), a flash ROM, and a RAM (Random Access Memory)). Further, the programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line such as an electric wire and an optical fiber or a wireless communication line.

An example of a hardware configuration of the determination unit and the wavelength instruction unit is shown. FIG. 10 is a diagram showing an example of a hardware configuration for implementing a determination unit and a wavelength instruction unit. The determination unit and the wavelength instruction unit can be implemented by a computer 9000 such as a dedicated computer or a personal computer (PC). However, the computer need not be a single physical computer, but may be a plurality of computers when the processing is performed in a distributed manner. As shown in FIG. 10, a computer 9000 includes a CPU (Central Processing Unit) 9001, a ROM (Read Only Memory) 9002, and a RAM (Random Access Memory) 9003, all of which are connected to each other through a bus 9004. Note that the description of OS software for operating the computer is omitted, but it is considered that a computer for forming a network analysis system is also provided.

An input/output interface 9005 is also connected to the bus 9004. For example, an input unit 9006 including a keyboard, a mouse, a sensor, and the like, a display including a CRT, an LCD, and the like, an output unit 9007 including a headphone, a speaker, and the like, a storage unit 9008 including a hard disk drive, and the like, and a communication unit 9009 including a modem, a terminal adapter, and the like are connected to the input/output interface 9005.

The CPU 9001 performs various processes according to various programs stored in the ROM 9002, or various programs from the storage unit 9008 loaded onto the RAM 9003, and in this example embodiment, performs the processes of the determination unit and the wavelength instruction unit. Note that similarly to the CPU 9001, a GPU (Graphics Processing Unit) may be provided to perform performs various processes according to various programs stored in the ROM 9002, or various programs from the storage unit 9008 loaded onto the RAM 9003, and in this example embodiment, performs the processes of the determination unit and the wavelength instruction unit. Note that the GPU is suitable for use in which routine processes are performed in parallel, and can improve the processing speed compared to the CPU 9001 by applying it to, for example, processes in a neural network. In the RAM 9003, data necessary for the CPU 9001 and the GPU to perform various processes are also stored.

The communication unit 9009 performs, for example, communication processing through the Internet (not shown), transmits data provided from the CPU 9001, and outputs data received from an entity or the like with which the communication unit 9009 communicates to the CPU 9001, the RAM 9003, and the storage unit 9008. The storage unit 9008 exchanges data and the like with the CPU 9001, and thereby store and erase information. The communication unit 9009 also performs communication processing for analog or digital signals with other apparatuses.

A drive 9010 is connected to the input/output interface 9005 as appropriate. For example, a magnetic disk 9011, an optical disk 9012, a flexible disk 9013, or a semiconductor memory 9014, and the like are mounted on or attached to the input/output interface 9005, and computer programs read therefrom are installed in the storage unit 9008 as needed.

In the above-described embodiments, for the sake of simplicity, the communication apparatus has been described as having three or four optical transceivers, but this is merely an example. The communication apparatus may be provided with any number of optical transceivers.

In the example embodiments described above, the optical signal IN2 has been described as the wavelength multiplexed optical signal, but this is merely an example. The optical signal IN2 may be a single-wavelength optical signal.

The first to fifth embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

Each of the drawings is merely an example for explaining one or more example embodiments. Each of the drawings is not associated with only one particular example embodiment, but may be associated with one or more other example embodiments. As will be appreciated by those skilled in the art, various features or steps described with reference to any one of the drawings may be combined with features or steps shown in one or more other figures to, for example, create an example embodiment that is not explicitly shown or described in the present disclosure. Not all of the features or steps shown in any one of the drawings are required to explain an example embodiment, and some of the features or steps may be omitted. The order of the steps described in any one of the drawings may be changed as appropriate.

While the present disclosure has been described above with reference to example embodiments, the present disclosure is not limited to the example embodiments described above. Various modifications may be made to the structure and details of the present disclosure as would be understood by those skilled in the art within the scope of the present disclosure. Each example embodiments may then be combined with other example embodiments as appropriate.

The whole or part of the example embodiments disclosed above can be described as, but not limited to, the following supplementary notes.

### (Supplementary Note 1)

An optical transceiver including: first reception means for receiving a first optical signal including identification information and reception wavelength information; determination means for determining whether the identification information satisfies a predetermined condition; wavelength filter having a transmission wavelength that is tunable and transmitting a second optical signal of the transmission wavelength included in an input optical signal; instruction means for instructing the wavelength filter to use the transmission wavelength based on the reception wavelength information in a case where the determination means determines that the identification information satisfies the predetermined condition; and second reception means for receiving the second optical signal.

### (Supplementary Note 2)

The optical transceiver according to Supplementary note 1, in which the determination unit determines performs determination whether the optical transceiver provided with the determination means is specified as an optical transceiver for receiving the first optical signal as determination whether the predetermined condition is satisfied.

### (Supplementary Note 3)

The optical transceiver according to Supplementary note 1 or 2, further including optical branching means for branching a third optical signal including the first optical signal and the second optical signal to the first reception means and the wavelength filter.

### (Supplementary Note 4)

The optical transceiver according to Supplementary note 3, in which the third optical signal is obtained by superimposing the first optical signal by modulating an optical signal including the second optical signal.

(Supplementary Note 5) The optical transceiver according to Supplementary note 1 or 2, in which the first optical signal and the second optical signal are input at different timings, and the first reception means receives the first optical signal according to an input timing.

### (Supplementary Note 6)

The optical transceiver according to Supplementary note 1 or 2, further including wavelength separation means for wavelength-separating the first optical signal from a third optical signal including the first optical signal and the second optical signal, which have different wavelengths, outputting the separated first optical signal to the first reception means, and outputting optical signals other than the first optical signal to the wavelength filter.

### (Supplementary Note 7)

The optical transceiver according to any one of Supplementary notes 1 to 6, further including: a wavelength-tunable light source; drive means for outputting a drive signal in response to an external data signal, and a modulator for modulating a light output from the wavelength-tunable light source in response to the drive signal and outputting a modulated fourth optical signal, in which the first optical signal further includes transmission wavelength information, and in a case where the determination means determines that the identification information satisfies the predetermined condition, the instruction means instructs the wavelength-tunable light source to use a wavelength of the light to be output based on the transmission wavelength information.

### (Supplementary Note 8)

The optical transceiver according to Supplementary note 7, further including: optical branching means for branching an input optical signal to the first reception means and the wavelength filter; and optical distribution means for receiving a third optical signal including the first optical signal and the second optical signal through an input/output port connected to a communication partner, outputting the third optical signal to the optical branching means, and outputting the fourth optical signal output from the modulator to the input/output port.

### (Supplementary Note 9)

The optical transceiver according to Supplementary note 7, further including: wavelength separation means for wavelength-separating the first optical signal from a third optical signal in which at least the first optical signal and the second optical signal, which have different wavelengths, outputting the separated first optical signal to the first reception means, and outputting optical signals other than the first optical signal to the wavelength filter; and optical distribution means for receiving the third optical signal through an input/output port connected to a communication partner, outputting the third optical signal to the optical separation means, and outputting the fourth optical signal output from the modulator to the input/output port.

### (Supplementary Note 10)

The optical transceiver according to any one of Supplementary notes 1 to 9, in which a plurality of optical transceivers including the optical transceiver and one or more other optical transceivers are connected to optical signal distribution means, the first optical signal is transmitted to the optical signal distribution means from an optical transceiver of a communication partner of the optical transceiver or an optical transceiver used for transmitting the first optical signal, and the optical signal distribution means distributes the first optical signal to the plurality of optical transceivers.

### (Supplementary Note 11)

An optical communication system including: first and second communication apparatuses provided with a plurality of optical transceivers, respectively; in which at least one of the plurality of optical transceivers of the first communication apparatus includes: first reception means for receiving a first optical signal including identification information and reception wavelength information output from any one of the plurality of optical transceivers of the second communication apparatus; determination means for determining whether the identification information satisfies a predetermined condition; wavelength filter having a transmission wavelength that is tunable and transmitting a second optical signal of the transmission wavelength included in an input optical signal; instruction means for instructing the wavelength filter to use the transmission wavelength based on the reception wavelength information in a case where the determination means determines that the identification information satisfies the predetermined condition; and second reception means for receiving the second optical signal.

### (Supplementary Note 12)

A method for receiving an optical signal including: receiving a first optical signal including identification information and reception wavelength information; determining whether the identification information satisfies a predetermined condition; instructing a wavelength filter having a transmission wavelength that is tunable and transmitting a second optical signal of the transmission wavelength included in an input optical signal to use the transmission wavelength based on the reception wavelength information in a case where it is determined that the identification information satisfies the predetermined condition; and receiving the second optical signal.

### (Supplementary Note 13)

A program to cause a computer to execute steps of: determining whether identification information satisfies a predetermined condition, the identification information being obtained by receiving a first optical signal including the identification information and reception wavelength information; instructing a wavelength filter having a transmission wavelength that is tunable and transmitting a second optical signal of the transmission wavelength, which is to be received, included in an input optical signal to use the transmission wavelength based on the reception wavelength information in a case where it is determined that the identification information satisfies the predetermined condition.

What is claimed is:

1. An optical transceiver comprising:
a first reception unit configured to receive a first optical signal including identification information and reception wavelength information;
a determination unit configured to determine whether the identification information satisfies a predetermined condition;
a wavelength filter having a transmission wavelength that is tunable and configured to transmit a second optical signal of the transmission wavelength included in an input optical signal;
an instruction unit configured to instruct the wavelength filter to use the transmission wavelength based on the reception wavelength information in a case where the determination unit determines that the identification information satisfies the predetermined condition; and
a second reception unit configured to receive the second optical signal.

2. The optical transceiver according to claim 1, wherein the determination unit determines performs determination whether the optical transceiver provided with the determination unit is specified as an optical transceiver for receiving the first optical signal as determination whether the predetermined condition is satisfied.

3. The optical transceiver according to claim 1, further comprising an optical branching unit configured to branch a third optical signal including the first optical signal and the second optical signal to the first reception unit and the wavelength filter.

4. The optical transceiver according to claim 3, wherein the third optical signal is obtained by superimposing the first optical signal by modulating an optical signal including the second optical signal.

5. The optical transceiver according to claim 1, wherein the first optical signal and the second optical signal are input at different timings, and the first reception unit receives the first optical signal according to an input timing.

6. The optical transceiver according to claim 1, further comprising an optical branching unit configured to wavelength-separate the first optical signal from a third optical signal including the first optical signal and the second optical signal, which have different wavelengths, output the separated first optical signal to the first reception unit, and output optical signals other than the first optical signal to the wavelength filter.

7. The optical transceiver according to claim 1, further comprising:
a wavelength-tunable light source; a drive unit configured to output a drive signal in response to an external data signal, and
a modulator configured to modulate a light output from the wavelength-tunable light source in response to the drive signal and output a modulated fourth optical signal,
wherein the first optical signal further includes transmission wavelength information, and
in a case where the determination unit determines that the identification information satisfies the predetermined condition, the instruction unit instructs the wavelength-tunable light source to use a wavelength of the light to be output based on the transmission wavelength information.

8. The optical transceiver according to claim 7, further comprising:
an optical branching unit configured to branch an input optical signal to the first reception unit and the wavelength filter; and
an optical distribution unit configured to receive a third optical signal including the first optical signal and the second optical signal through an input/output port connected to a communication partner, output the third optical signal to the optical branching unit, and output the fourth optical signal output from the modulator to the input/output port.

9. The optical transceiver according to claim 7, further comprising:
an optical branching unit configured to wavelength-separate the first optical signal from a third optical signal in which at least the first optical signal and the second optical signal, which have different wavelengths, output the separated first optical signal to the first reception means, and output optical signals other than the first optical signal to the wavelength filter; and
an optical distribution unit configured to receive the third optical signal through an input/output port connected to a communication partner, output the third optical signal to the optical branching unit, and output the fourth optical signal output from the modulator to the input/output port.

10. The optical transceiver according to claim 1, wherein
a plurality of optical transceivers including the optical transceiver and one or more other optical transceivers are connected to optical signal distribution unit,
the first optical signal is transmitted to the optical signal distribution unit means from an optical transceiver of a communication partner of the optical transceiver or an optical transceiver used for transmitting the first optical signal, and
the optical signal distribution unit distributes the first optical signal to the plurality of optical transceivers.

11. An optical communication system comprising first and second communication apparatuses provided with a plurality of optical transceivers, respectively,
wherein at least one of the plurality of optical transceivers of the first communication apparatus comprises:
a first reception unit configured to receive a first optical signal including identification information and reception wavelength information output from any one of the plurality of optical transceivers of the second communication apparatus;
a determination unit configured to determine whether the identification information satisfies a predetermined condition;
a wavelength filter having a transmission wavelength that is tunable and configured to transmit a second optical signal of the transmission wavelength included in an input optical signal;
an instruction unit configured to instruct the wavelength filter to use the transmission wavelength based on the reception wavelength information in a case where the determination means determines that the identification information satisfies the predetermined condition; and
a second reception unit configured to receive the second optical signal.

12. A method for receiving an optical signal comprising:
receiving a first optical signal including identification information and reception wavelength information;
determining whether the identification information satisfies a predetermined condition;
instructing a wavelength filter that has a transmission wavelength that is tunable and configured to transmit a second optical signal of the transmission wavelength included in an input optical signal to use the transmission wavelength based on the reception wavelength information in a case where it is determined that the identification information satisfies the predetermined condition; and
receiving the second optical signal.
